(19) United States
(12) Patent Application Publication
(10) Pub. No.: US 2010/0067416 A1
(43) Pub. Date: Mar. 18, 2010

(54) RE-PROGRAMMING MEDIA FLOW PHONE USING SPEED CHANNEL SWITCH TIME THROUGH SLEEP TIME LINE

(75) Inventors: Ying Gao, San Diego, CA (US); Tadeusz Jarosinski, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/211,011

(22) Filed: Sep. 15, 2008

(51) Int. Cl. G08C 17/00

(52) U.S. Cl. 370/311

(57) ABSTRACT

A multicasts wireless telecommunication system to reprogram preset sleep time line to earlier point to wake up ASIC at right moment to obtain new channel OIS to prevent screen in the device display from going black, and save power by saving extra wakeup time and extra going to sleep cycles.

### BACKGROUND

1. Field

The present invention relates generally to channel switch that asynchronously happens at any time during the Audio/Video playing time when a phone is sleeping between clusters to effect sleep abort to act on the channel switch command promptly, and that always results in timing lost, so that the physical layer has to re-align time, which could take as long as 1 second, thereby causing the screen to go black due to the data demodulation failure in the ASIC. More specifically, the invention pertains to the use of a sleep time reprogram technique that does not awaken or wake up the ASIC, but changes the sleep end (wake up time) to an earlier point to ensure that the ASIC wakes up at the right moment to obtain new channel overhead information, and thereby prevent the screen from going black and also save power by saving extra wakeup and an extra going to sleep cycle.

2. Background

A method of channel switching in a packet-based wireless communication network, where data traffic takes place on a first channel that is controlled by a central control unit which indicates its presence on the first channel by transmitting regular beacons with a specified time interval, and where devices associated with the central control unit are active, or leaving sleep mode to listen for pending data traffic at specified time intervals is disclosed in U.S. Pat. 7,231,215. The method comprises the steps of: detecting a radar signal on the first channel and in response to the detection interrupting the data traffic on the first channel, transmitting a first channel switch message on the first channel, signaling to active and/or listening devices that a channel switch to a second channel will occur, wherein a channel switch count is set to zero in the first channel switch message, thus signaling to active and/or listening devices that a channel switch will occur immediately after the beacon transmission.

Published U.S. Patent Application No. 2006/0252420. disclose a mobile communication device that determines when a performance disruption indicates a loss of synchronization with a broadcast signal and, in response, initiates reacquisition of the signal. The reacquisition techniques may include identifying and decoding only select portions of header information in the broadcast signal. Reacquisition may also be initiated in response to one or more deterministic triggers and during a test mode of operation.

FA station connecting to an access point of a wireless local area network (WLAN) is disclosed in U.S. Published Patent Application No. 2007248034, wherein a radio frequency (RF) module demodulates received radio signals into baseband signals. A baseband module, coupled to the RF module, converts the baseband signals to a bit stream. A media access control (MAC) module, coupled to the baseband module, processes the bit stream to obtain data packets. An application specific integrated circuit (ASIC), coupled to the baseband module, and MAC module, causes the station to enter a sleep mode, wakes up at least one of the components of the station at a preset original wake-up time to receive a beacon frame from the access point, parses the beacon frame to extract traffic indication map (TIM) information specified therein, and determines a next wake-up time by adjusting the original wake-up time according to the TIM information.

WO/2003/017596 disclose a dual mode Bluetooth/wireless mobile unit, wherein the next sleep mode Bluetooth wakeup time is rescheduled to synchronize with any upcoming idle mode wireless wakeup time that will otherwise precede the Bluetooth wakeup time. The Bluetooth clock is advanced, or other reconfiguration made to the Bluetooth module, as appropriate to prevent the scanning frequency from changing during a sleep mode Bluetooth wakeup/scanning interval commencing at the resynchronized Bluetooth wakeup time.

A single application specific integrated circuit (ASIC) die that is capable of supporting a plurality of different interfaces is disclosed in WO/2004061907. The ASIC die includes elements that are common to the different interfaces, elements that are unique to each of the different interfaces, and a plurality of switches. In one embodiment, Interface controller 412 can detect a specific wake-up signal (or some other low-level or out-of-band signaling)’ that is only used with the first interface, and then implement switching within ASIC 204 such that first interface specific elements 406 are used with common elements 404, to support the interface.

U.S. Pat. No. 5,737,323 disclose a mobile telephone that has a high frequency system clock (41) and a processor (61) arranged to process polling signals received while the telephone is in its standby condition. When polling signals are not being received, it is possible for the telephone to be placed in a sleep condition, by de-activating the system clock. Re-activation occurs in response to a calibrated number of clock cycles produced by a lower frequency sleep clock (65). Upon re-activation, system clock counters (43,44), specifying sub-frame periods and frame periods are re-loaded so that they may be re-activated at the required phase. The phase of these counters is compared with signals received from base stations and modifications are made to system counts as required. The extent to which modifications are required is also used to re-calibrate the sleep clock.

There is a need to use a software (SW) read sleep counter register to figure out how much time has elapsed and whether this elapsed time is a good time to reprogram the sleep time—and if it is the proper time (not too late) the software will immediately re-calculate the sleep time line using the new wake up time (wherein the new wakeup time is before the scattered frequency (SF) boundary with a small margin). That way, when the ASIC synchronously wakes up before the SF boundary, the SW programs the HW to get the OIS of the channel switch.

### SUMMARY

Embodiments disclosed herein address the above stated needs by solving the channel switch delay problem occurring during the device's sleep across superframe, wherein a wakeup approach is used to reprogram the sleep time line with a new wakeup end point. Reprogramming the sleep time line preserves the system timing by keeping the sleep routine scheduled to wake up synchronously by reading the sleep count register to calculate how much time has elapsed and what hardware state it is in. Based upon the hardware sleep module station machine, the sleep time line can only be re-programmed in certain states. By reading the sleep count, we ensure that we are in the right time to re-program the sleep time line to provide a new wake up end point.

The new wakeup end point enables the device to wakeup early enough to decode the OIS. Use of this new wakeup end point and recalculation of the sleep time line enables programming them to the HW. With the new total sleep system count and new wakeup system time the hardware sleeps up to the moment that it reaches the new total sleep cycle count, and then wakes up and restores the new system time programmed to the hardware as a result of the sleep time line reprogramming.

### BRIEF DESCRIPTION OF DRAWINGS

FIG. 1 is a flow chart of procedure for reprogramming the sleep time line in the driver of the protocol stack software.

FIG. 2 shows the location and relationship of OIS channel and data channel in Forward Link Only (FLO) superframe structure.

FIG. 3 is a block diagram of the scenario of sleep across superframe when the device is continuously decoding.

FIG. 4 is a block diagram that shows when channel switch happens during the sleep across the superframe, where reprogramming sleep time line will make wakeup happen earlier for OIS decoding in next superframe.

FIG. 5 is a chart showing the state of the hardware sleep module device.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

An HDR subscriber station, referred to herein as an access terminal (AT), may be mobile or stationary, and may communicate with one or more HDR base stations, referred to herein as modem pool transceivers (MPTs). An access terminal transmits and receives data packets through one or more modem pool transceivers to an HDR base station controller, referred to herein as a modem pool controller (MPC). Modem pool transceivers and modem pool controllers are parts of a network called an access network. An access network transports data packets between multiple access terminals. The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link. The communication link through which a modem pool transceiver sends signals to an access terminal is called a forward link.

To resolve the channel switch delay problem which happens during the device's sleep across the superframe, a wakeup approach is utilized to abort sleep, thereby leading the system to totally lose timing. The device cannot decode any data without requiring the system to re-gain the timing. Therefore, it may cause an additional channel switch delay up to more than one second during which no data can be decoded, thereby resulting in a black screen in the device display.

To avoid asynchronous wakeup (abrupt wakeup), the present method reprograms the sleep time line with a new wakeup end point. Reprogramming the sleep time line preserves the system timing by keeping the sleep routine schedule and wakeup synchronously. During the sleep, it reads the sleep count register to calculate how much time has elapsed and what the hardware is at. Based upon the hardware sleep module station machine, the sleep time line can only be re-programmed in certain states. Reading the sleep count ensures that we are in the right time to re-program the sleep time line.

The new wakeup end point enables the device to wakeup early enough to decode the OIS. Using this new wakeup end point and recalculating the sleep time line enables us to program them to the HW. With the new total sleep cycle count, and new wakeup system time, the hardware sleeps until the moment it reaches the new total sleep cycle count, and then wakes up and restores the new system time programmed to the hardware as a result of the sleep time line reprogramming. Consequently, the device is able to change the sleep time line after it is put into the sleep mode, and wakes up earlier and gets the OIS. With the OIS information, the new flow can be programmed into the hardware on time and be decoded immediately.

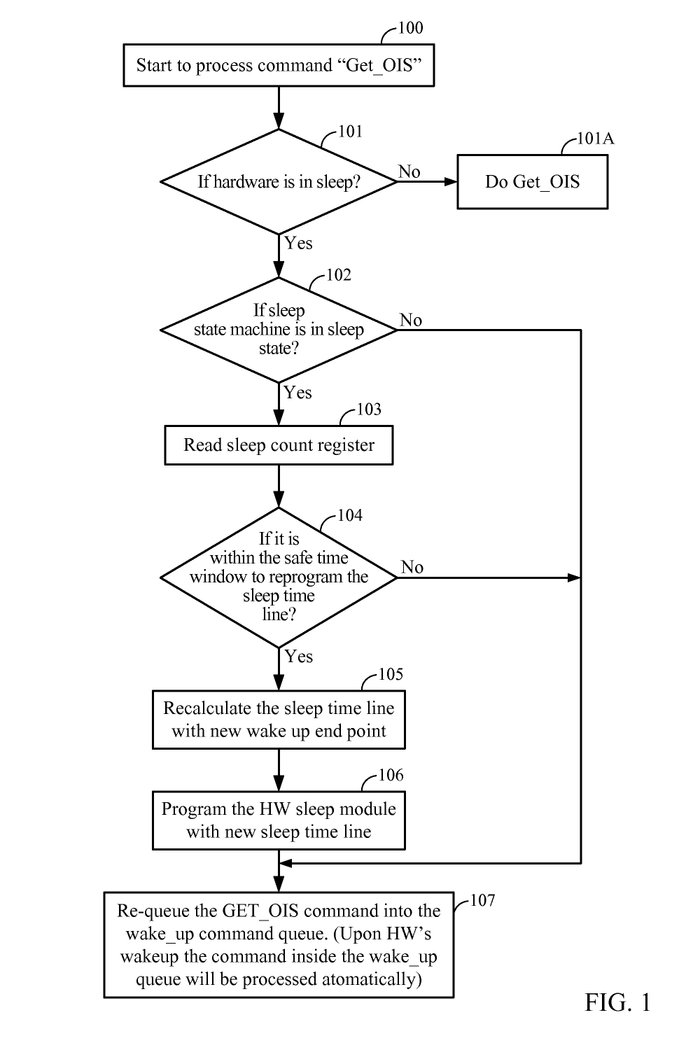

Referring now to FIG. 1, a flow chart depicts the procedure for re-programming the sleep time line in the driver of the protocol stack software. At 100, the process to start the command to get the OIS is begun and if the answer to the question, if the hardware is in the sleep mode is yes at 101, the process moves to the next step 102 to ascertain whether the sleep state machine is in the sleep state. If the answer is yes, the process moves to the read sleep count register 103 to ascertain whether at 104, if it is within the safe time window to reprogram the sleep timeline. If the answer is yes, the re-calculation of the sleep time line with the new wake up end point is effected at 105 and the process proceeds further to step 106 where the hardware sleep module is programmed with the new sleep timeline. Thereafter, at step 107, requeue is performed to get the OIS command into the wakeup command queue, wherein upon the HW's wake up, the command inside the wakeup queue is processed automatically. On the other hand, if at step 101 the answer is no to the question whether the hardware is in sleep, the process is diverted to step 101a in order to get the OIS.

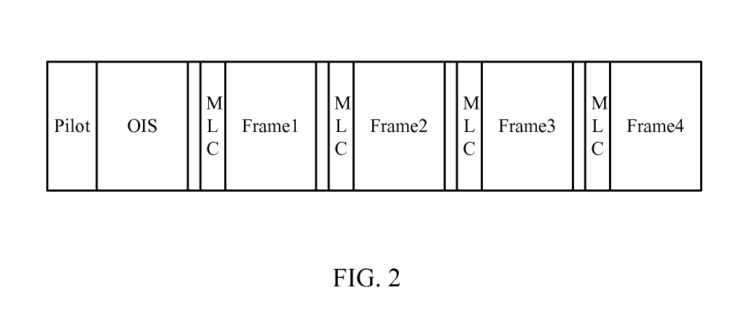

FIG. 2 shows the location and relationship of the OIS channel and data channel in the forward link only (FLO) air interface by way of the super frame structure, wherein rapid channel acquisition is achieved through an optimized pilot and interleaver structure design. The interleaving schemes incorporated in the FLO air interface simultaneously assure time diversity. Here, the pilot structure and interleaver design optimizes channel utilization without perturbing the user with long acquisition times. The FLO transmitted signal is organized into super frames, wherein each super frame is comprised of four frames of data, including the TDM pilots, the overhead information symbols (OIS) and frames containing wide-area and local-area data. In general, each super frame consists of 200 OFDM symbols per MHz of allocated bandwidth (1200 symbols of 6 MHz), and each symbol contains 7 interlaces of active subcarriers. Each interlace is uniformly distributed in frequency, so that it achieves the full frequency diversity within the available bandwidth. These interlaces are assigned to logical channels that vary in terms of duration and number of actual interfaces used to provide flexibility in the time diversity achieved by any given data source. Lower data rate channels can be assigned fewer interlaces to provide time diversity, while higher data rate channels utilize more interlaces to minimize the signal on-time and reduce power consumption. The acquisition time for both low and high data rate channels is approximately the same. Both frequency and time diversity can be maintained without compromising acquisition time.

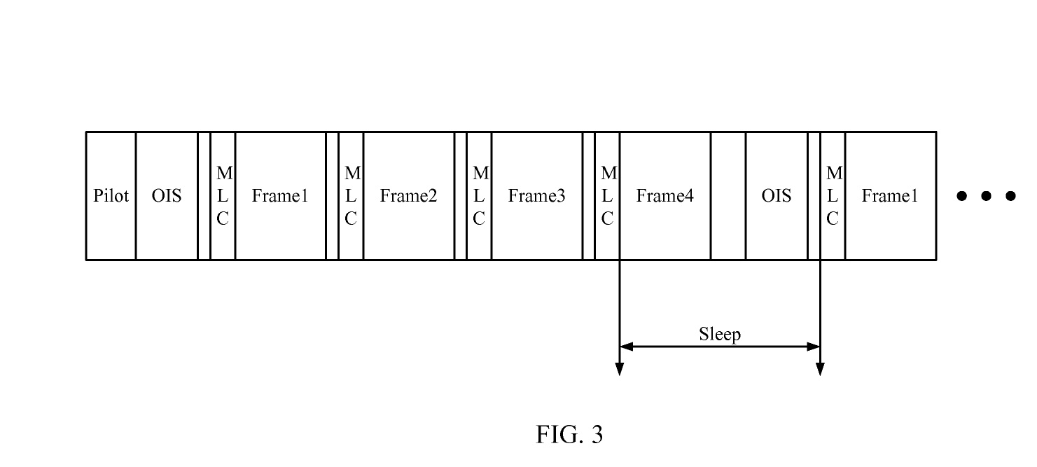

However, the problem is how to achieve channel switch when the application/users triggers the channel switch when the device is sleeping across super frames for continuous MLC decoding, as shown in FIG. 3, which depicts the sleep across super frame, wakeup just before the MLC in frame 1 in the next superframe.

For example in FIG. 3, at the time device there is streaming a pair of audio and video flows, where there is a user triggered switch channel. A pair of new audio and video flows are activated and need to program into hardware to decode as soon as possible. Due to FLO physical layer structures and FLO Air Interface Specification, OIS information is needed for the new MLCs to be programed and decoded correctly. However, before the channel switch is triggered by the application/users, the sleep time line has already been programmed into the hardware to summons wake up before the first MLC in the next superframe. To keep the sleep time line as it is, the OIS in the next superframe is skipped. Therefore, the device can't decode the OIS until the superframe after next. So the channel switch will be delayed by an extra one second.

One alternative approach, which is not part of the invention process, is to wake up the device immediately so that OIS can be decoded on time for MLCs to be programmed and decoded in the next superframe. But asynchronously waking up the device makes the device lose timing, and the device can not decode MLCs any more after it loses timing. Further, the system re-acquisition may take more than one second to recover the timing, and this could result in a black screen which is very undesirable for the user.

The present process addresses this dilemma to speed channel switch by re-programming the sleep time line to ensure a synchronous wakeup instead of rude waking up of the device.

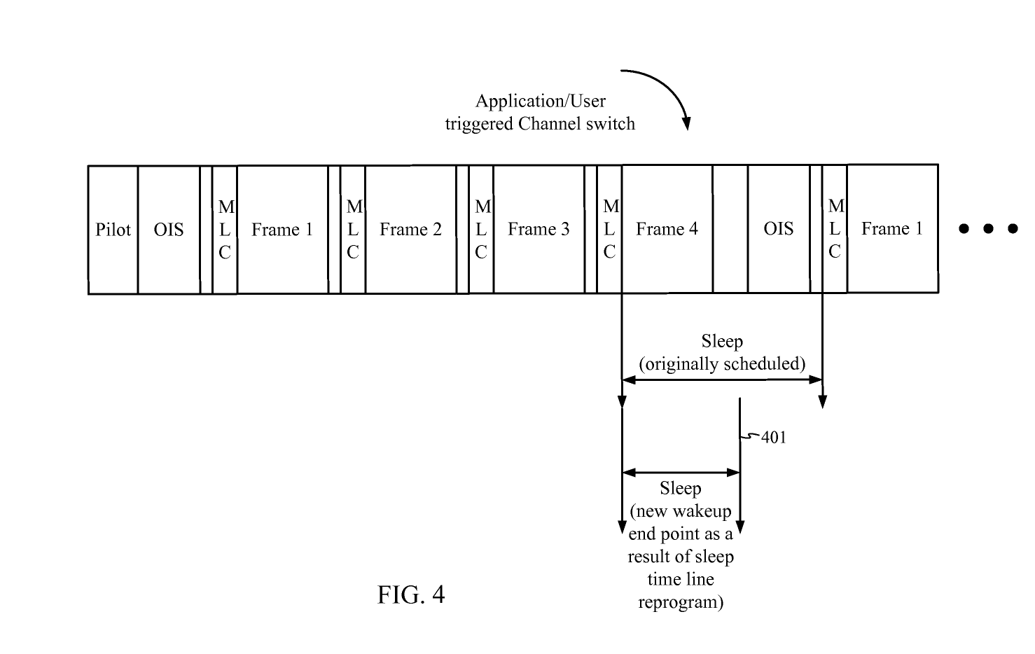

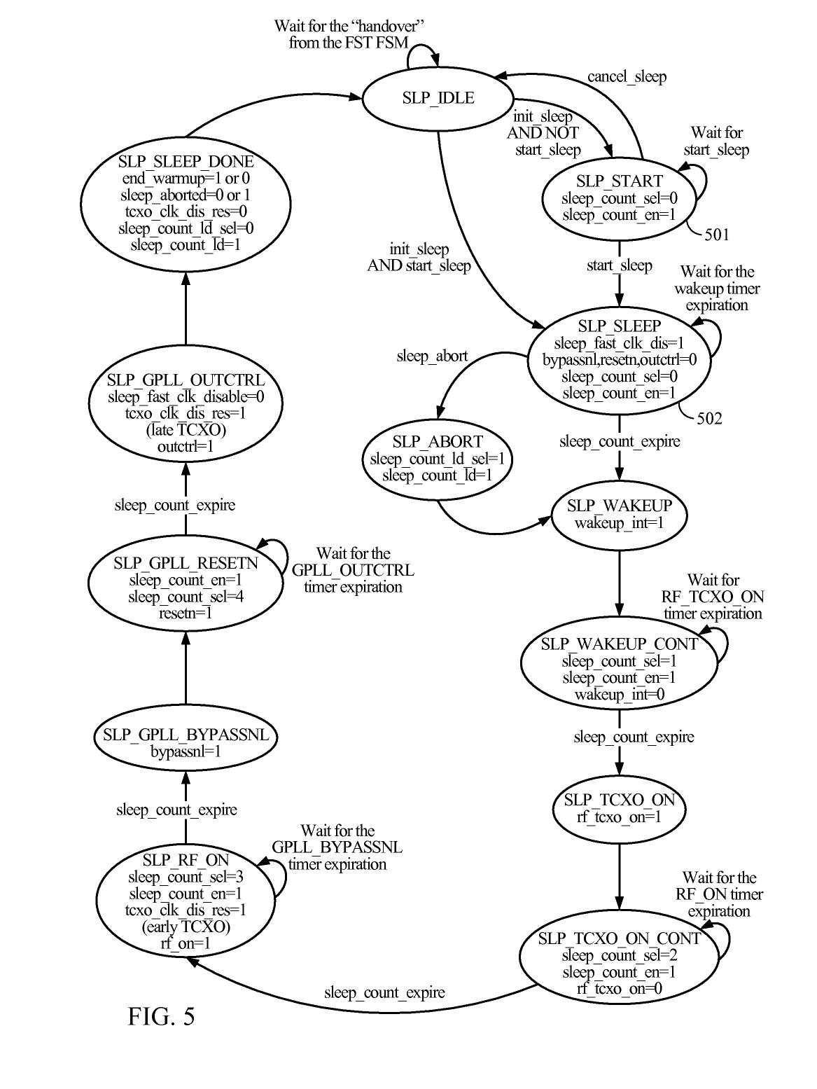

FIG. 4 is an exemplary embodiment of the present process showing that the channel switch happens during the moment the device is asleep across the superframe, where the device protocol stack software activates the new flows in the upper layer, and post a Get_OIS command to the driver layer of the stack. Upon getting this command into the process, the driver software checks to see if the device is sleeping. If it is sleeping, it reads the sleep_counter register from the hardware which indicates how many clock cycles had elapsed in this sleep operation so far. By doing this, the driver software figures out which state the hardware sleep module is currently at. It is only safe to reprogram the sleep time line in certain states of the FSM machine of the HW module, as shown at 502 in FIG. 5. The driver software uses the new wakeup end point 401 to re-calculate the sleep time line and obtains the new total sleep clock cycle and new system time for the new wakeup time. The new wakeup end point 401 should be moved earlier to let the device wakeup early enough to decode OIS in the next superframe. The new total sleep clock cycle counter has been re-programmed and updated, but mean while the sleep operation is going on without being interrupted. When it sleeps to the moment that reaches the total sleep clock cycle counter, the sleep module wakes the hardware up and restores the system time with the newly programmed system time. Thus, the present process reprograms the device sleep time line to make it wakeup earlier to fulfill the fast channel switch without abruptly waking up the device.

As can be seen from the flow chart embodiment of the hardware sleep module FSM machine in FIG. 5, reprogramming the sleep time line preserves the system timing by keeping the sleep routine scheduled and the wakeup synchronously starting the sleep count start at 501. During the sleep, it reads a sleep count register to calculate how much time has elapsed and what state the hardware is at. Based upon the hardware sleep module station machine, the sleep timeline can only be re-programmed at SLP_SLEEP states at 502, therefore reading the sleep count is to make sure of being in the right time to re-program the sleep timeline.

While the method or steps of reprogramming have been set out in a representative sequence in the embodiments described, it is to be understood by the skilled worker in the art that these steps can be interchanged without departing from the scope of the invention as long as the reprogramming is done at the SLP_SLEEP state.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim:

1. In a multicasts wireless telecommunication system providing an aggregation of one or more independent data components as a flow, and wherein a user/application switch channel is employed to deactivate existing flows and activate new flows, the improvement of reprogramming the preset sleep time line to an earlier point to ensure that the ASIC wakes up at the right moment to obtain new channel OIS to prevent the screen in the device display from going black, and to save power by saving extra wakeup time and extra going to sleep cycles, comprising:
a) starting the process to command the GET_OIS;
b) determining if the hardware is in the sleep mode;
c) determining if the sleep state machine is in the sleep state;
d) reading the sleep count register to ascertain how much time has elapsed in the hardware sleep module station machine and to determine if it is in the safe time window to reprogram the preset sleep time line;
e) re-calculating the sleep time line with the new wake up end point;
f) reprogramming the HW sleep module with the new sleep time line; and
g) re-queueing the GET_OIS command into the wakeup command queue, so that upon the HW's wake up the command inside the wake_up queue is processed automatically.

2. The method of claim 1, wherein the flow is audio.

3. The method of claim 1, wherein the flow is video.

4. The method of claim 1, wherein the flow is text.

5. The method of claim 1, wherein the flow is signaling.

6. The method of claim 1, wherein the flow is audio/video.

7. The method of claim 1, wherein the flow is a combination of audio/video/text and signalling.

8. The method of claim 1, wherein the safe time window is at the SLP_SLEEP.

9. A computer readable medium embodying reprogramming a preset time line in a multicasts wireless telecommunication system that provides an aggregation of one or more independent data components as a flow, in a user/application switch channel to deactivate existing flows and activate new flow, comprising:
a) starting the process to command the GET_OIS;
b) determining if the hardware is in the sleep mode;
d) determining if the sleep state machine is in the sleep state;
d) reading the sleep count register to ascertain how much time has elapsed in the hardware sleep module station machine and to determine if it is in the safe time window to reprogram the preset sleep time line;
e) re-calculating the sleep time line with the new wake up end point;
f) reprogramming the HW sleep module with the new sleep time line; and
g) re-queueing the GET_OIS command into the wakeup command queue, so that upon the HW's wake up the command inside the wake_up queue is processed automatically.

10. The computer readable medium of claim 9, wherein the flow is audio.

11. The computer readable medium of claim 9, wherein the flow is video.

12. The computer readable medium of claim 9, wherein the flow is text.

13. The computer readable medium of claim 9, wherein the flow is signalling.

14. The computer readable medium of claim 9, wherein the flow is audio/video.

15. The computer readable medium of claim 9, wherein the flow is a combination of audio/video/text and signalling.

16. A multicasts wireless telecommunication system, that reprograms the preset sleep time line to an earlier point to ensure that the ASIC wakes up at the right moment to obtain new channel OIS to prevent the screen in the device display from going black, and save power by saving extra wake up and extra going to sleep cycles, comprising:
a) means for starting the process to command the GET_OIS;
b) means for determining if the hardware is in the sleep mode;
e) means for determining if the sleep state machine is in the sleep state;
d) means for reading the sleep count register to ascertain how much time has elapsed in the hardware sleep module station machine and to determine if it is in the safe time window to reprogram the preset sleep time line;
e) means for re-calculating the sleep time line with the new wake up end point;
f) means for reprogramming the HW sleep module with the new sleep time line; and
g) means for re-queueing the GET_OIS command into the wakeup command queue, so that upon the HW's wake up the command inside the wake_up queue is processed automatically.

17. The multicasts wireless telecommunication system of claim 16 wherein the flow is audio.

18. The multicasts wireless telecommunication system of claim 16 wherein the flow is video.

19. The multicasts wireless telecommunication system of claim 16 wherein the flow is text.

20. The multicasts wireless telecommunication system of claim 16 wherein the flow is signalling.

21. The multicasts wireless telecommunication system of claim 16 wherein the flow is a combination of audio/video/text and signalling.
